(19) United States
(12) Patent Application Publication
(10) Pub. No.: US 2023/0261468 A1
(43) Pub. Date: Aug. 17, 2023

(54) SYSTEM AND METHOD FOR DETERMINING POWER PRODUCTION IN AN ELECTRICAL POWER GRID

(71) Applicant: FORESIGHT ENERGY LTD., HOD HASHARON (IL)

(72) Inventors: Emek Sadot, Ram-On (IL); Evgeny Finkel, Petah-Tikva (IL); Sergel Edelstein, Herzliya (IL); Alla Volkov, Netanya (IL); Roman BABKIN, Lysohora (UA); Gregory BRAVERMAN, Herzeliya (IL)

(21) Appl. No.: 18/138,549

(22) Filed: Apr. 24, 2023

Related U.S. Application Data
(63) Continuation-in-part of application No. 17/367,480, filed on Jul. 5, 2021.
Application No. 17/367,480 is a continuation-in-part of application No. 15/890,358, filed on Feb. 7, 2018, now abandoned.
(60) Provisional application No. 62/455,611, filed on Feb. 7, 2017.

(51) Int. Cl. H02J 3/00; G05B 13/02; G05B 13/04; G06Q 10/0631; G06Q 50/06; H02J 3/32

(52) U.S. Cl. CPC H02J 3/003; G05B 13/0265; G05B 13/048; G06Q 10/06315; G06Q 50/06; H02J 3/32; H02J 2203/20

(57) ABSTRACT

There is provided a technique of managing an electrical power grid. The technique comprises, by a computer: processing timestamped data informative of weather conditions and of individual grid power consumption by a plurality of consumers to identify dual consumers connected to alternative power sources with power generating dependable on the weather conditions; for the dual consumers, forecasting alternative power production by respective connected alternative power sources; and using the provided forecast to enable management action(s) with regard to power production in the electrical power grid (e.g. issuing command(s) related to charging/discharging one or more batteries connected to the grid, controlling thermostat set-point change in a set of points connected to the grid, etc.). Forecasting alternative power production can be provided using a trained Forecasting Machine Learning Model trained to forecast the alternative power production in accordance with a forecast of the one or more weather conditions in the geographical area.

### CROSS-REFERENCE TO RELATED APPLICATIONS

This application is a continuation-in-part of U.S. patent application Ser. No. 17/367,480, filed Jul. 5, 2021, that is a continuation-in-part of U.S. patent application Ser. No. 15/890,358, filed Feb. 7, 2018, which claims the benefit of U.S. Provisional Patent Application No. 62/455,611, filed Feb. 7, 2017, all applications are hereby incorporated by reference.

### TECHNICAL FIELD

The present invention relates to electrical power grids. More particularly, the present invention relates to systems and methods of managing an electrical power grid in accordance with determination and/or forecasting of power production.

### BACKGROUND

In recent years, power consumption data has become available to providers (e.g. power plants) utilizing “smart” power consumption meters (referred to hereinafter also as “smart” meters). These “smart” meters are usually directly coupled to a consumer (e.g.to a power grid of a private household) and are configured to continuously measure the consumer's power consumption and store the respective values. The “smart” meters are further configured to transfer (in pull and/or push mode) the measurement results and/or derivatives thereof to the power provider via a communication network. Thus, the power provider can continuously receive from the meters the power consumption data of the respective consumers and monitor the power consumption accordingly.

While a vast amount of power consumption data is available, there is still a need for a way to manage all of this data to determine power consumption and power production in electrical power grids.

### GENERAL DESCRIPTION

In accordance with certain aspects of the presently disclosed subject matter, there is provided a method of managing an electrical power grid operatively connected to a plurality of consumers in a geographical area. The method comprises the following operations provided by a computer: processing timestamped data informative of one or more weather conditions and of individual grid power consumption (GPC) by a plurality of consumers to identify one or more dual consumers connected to one or more alternative power sources with power generating dependable on the one or more weather conditions; for the identified one or more dual consumers, forecasting alternative power production by respective connected alternative power sources; and using the provided forecast to enable one or more management actions with regard to power production in the electrical power grid.

The one or more management actions can comprise issuing by the computer at least one command related to at least one of: charging/discharging one or more batteries connected to the grid and controlling thermostat set-point change in a set of points connected to the grid.

In accordance with further aspects of the presently disclosed subject matter, a dual consumer can be identified in accordance with a relationship between the consumer's individual GPC and the one or more weather conditions during a certain time period. For example, a dual consumer can be identified as having inverse relationship between the data informative of the consumer's individual GPC and the data informative of one or more weather conditions comparing to other consumers in a group of similar consumers. Alternatively or additionally, a dual consumer can be identified as having inverse relationship between the data informative of the consumer's individual GPC and the data informative of one or more weather conditions with the help of a machine learning model trained to identify patterns of GPC depending on weather conditions in the geographical area.

In accordance with further aspects of the presently disclosed subject matter, forecasting alternative power production by an alternative power source connected to a given dual consumer can be provided using a trained Forecasting Machine Learning (FML) Model trained to forecast the alternative power production in accordance with a forecast of the one or more weather conditions in the geographical area.

The method can further comprise processing the timestamped data to identify types of alternative power sources respectively connected to the identified one or more dual consumers, wherein, for the given consumer, the FML Model corresponds to an identified type of a connected alternative power source. Optionally, the type of the connected alternative energy source can be identified with the help of a machine learning model trained to identify patterns of alternative power production being a function of the one or more weather conditions in one or more geographical areas.

In accordance with further aspects of the presently disclosed subject matter, the method can further comprise: using a trained Forecasting Machine Learning (FML) Model to forecast, for each of identified dual consumers from a group of identified dual consumers, the alternative power production by a respectively connected alternative power source; and forecasting a total alternative power production in the group of dual consumers and using the provided forecast to enable management actions with regard to power production in the electrical power grid. The group of identified dual consumers can be constituted by at least one of: all identified dual consumers from the plurality of consumers, identified dual consumers having the same type of the alternative energy source, dual consumers having similar GPC patterns, dual consumers having similar GPC requirements, etc.

In accordance with further aspects of the presently disclosed subject matter, training the FML model can comprise: using historical data informative of the one or more weather conditions and of individual GPC by different consumers to obtain a plurality of FML models having different parameters and initially trained to forecast GPC in accordance with a forecast of the one or more weather conditions; using the plurality of initially trained FML models to forecast GPC in accordance with the one or more weather conditions forecasted for a testing period and thereby obtaining a set of net load data time series forecasted by the plurality of FML models; and comparing the forecasted net load data time series in the set of net load data time series with net load data time series measured during the testing period and selecting a FML model providing the best net load forecast for the testing period, thereby giving rise to the trained FML.

In accordance with other aspects of the presently disclosed subject matter, there is provided a system capable of managing an electrical power grid operatively connected to a plurality of consumers in a geographical area, the system comprising a computer configured to provide the operations of the method above.

In accordance with other aspects of the presently disclosed subject matter, there are provided one or more computers comprising processors and memory, the one or more computers configured, via computer-executable instructions, to perform operations for operating, in a cloud computing environment, a system capable of managing an electrical power grid operatively connected to a plurality of consumers in a geographical area, the operations comprising: processing timestamped data informative of one or more weather conditions and of individual grid power consumption (GPC) by a plurality of consumers to identify one or more dual consumers connected to one or more alternative power sources with power generating dependable on the one or more weather conditions, wherein a given dual consumer is identified in accordance with a relationship between the consumer's individual GPC and the one or more weather conditions during a certain time period; for the given dual consumer, using a trained Forecasting Machine Learning (FML) Model to forecast the alternative power production by a connected alternative power source, wherein the FML model is trained to forecast the alternative power production in accordance with a forecast of the one or more weather conditions in the geographical area; and using the provided forecast to enable one or more management actions with regard to power production in the electrical power grid.

In accordance with other aspects of the presently disclosed subject matter, there is provided a non-transitory computer readable medium comprising instructions that, when executed by one or more computers operating in a cloud computing environment, cause a system capable of managing an electrical power grid to operate in accordance with the method above.

Among advantages of certain embodiments of the presently disclosed subject matter is capability of predicting and, thereby, optimizing, by a management system, a network load of the electrical power grid in consideration of alternative power sources and of consumption from alternative power sources of one or more dual consumers.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, can best be understood by reference to the following detailed description when read with the accompanying drawings in which:

FIG. 1 illustrates a generalized diagram of an exemplary electrical power grid environment including a Power Grid Management System (PGMS) configured in accordance with certain embodiments of the presently disclosed subject matter;

FIG. 2 illustrates a generalized block diagram of the PGMS configured in accordance with certain embodiments of the presently disclosed subject matter.

FIGS. 3A-3B illustrate a generalized flowchart of determining alternative to an electrical power grid power production, in accordance with certain embodiments of the presently disclosed subject matter.

FIG. 4 illustrates a generalized flowchart of managing the electrical power grid in accordance with certain embodiments of the presently disclosed subject matter; and

FIG. 5 illustrates a generalized flowchart of forecasting the alternative power production in accordance with certain embodiments of the presently disclosed subject matter.

It will be appreciated that, for simplicity and clarity of illustration, elements shown in the figures have not necessarily been drawn to scale. For example, the dimensions of some of the elements can be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “forecasting”, “identifying”, “training” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, PGMS and processing and memory (PMC) circuitry therein disclosed in the present application.

The terms “non-transitory memory” and “non-transitory storage medium” used herein should be expansively construed to cover any volatile or non-volatile computer memory suitable to the presently disclosed subject matter.

Unless explicitly stated, the method embodiments described herein are not constrained to a particular order or sequence. Additionally, some of the described method embodiments or elements thereof can occur or be performed simultaneously, at the same point in time, or concurrently.

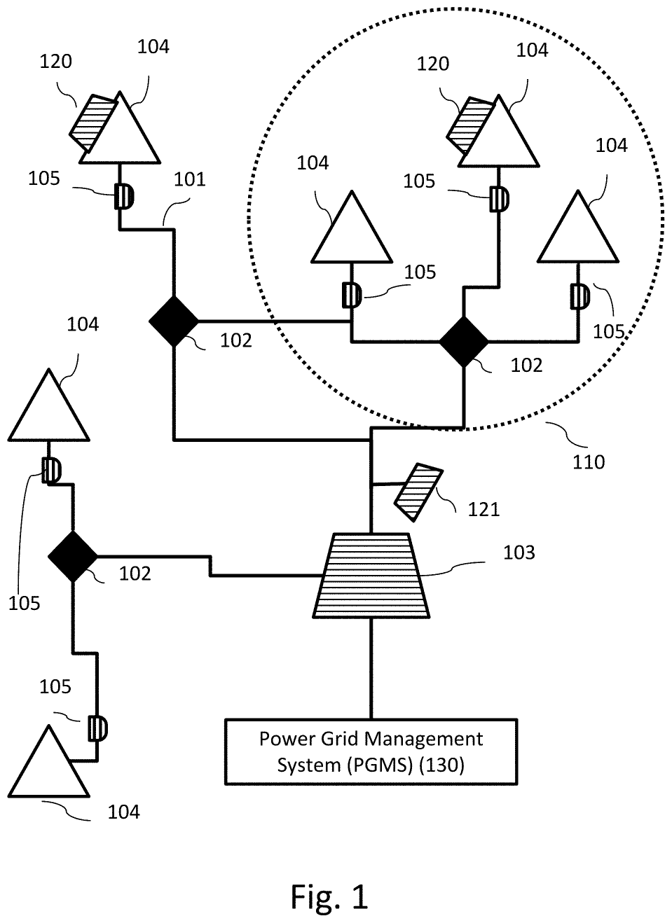

Bearing this in mind, attention is drawn to FIG. 1, illustrating a generalized diagram of an exemplary electrical power grid environment including a Power Grid Management System (PGMS) configured in accordance with certain embodiments of the presently disclosed subject mater.

The illustrated electrical power grid comprises a plurality of electrical power nodes (e.g. electrical power transformation centers, etc.) 102 that receive power from a central electrical power distributor 103 via transmission lines 101. The electrical power nodes 102 are configured to further distribute electrical power to consumers 104 (e.g., private households, office buildings, etc.) via transmission lines 101.

According to some embodiments, electrical power grid can comprise power consumption meters 105 (e.g. “smart meters”), each meter being associated with a respective consumer 104 and operatively connected thereto. Each meter can be configured to measure the power consumed by an associated consumer from the electrical power grid during a time interval (individual grid power consumption). Power consumption meters 105 are further configured to transfer (in pull and/or push mode) the measurement results and/or derivatives thereof. Thus, a power provider is enabled to monitor the power consumption of consumers 104 from the electrical power grid. It is noted that a site (e.g., a private household, an office building, etc.) is considered as consumer 104 when is associated and operatively connected to a respective power consumption meter 105.

One or more consumers of the electrical power grid can be connected to one or more energy sources 120 (e.g. solar panels, wind turbines, biomass-based generators, batteries, etc.) that can be included or not included in the power grid. Such consumers are referred to hereinafter also as a “dual consumer”. Energy generation by some of such sources (e.g. photovoltaic generation, wind power generation, etc.) can be dependable on weather conditions (e.g. solar irradiance, wind power, etc.) and vary accordingly.

Unless specifically stated otherwise, the energy sources that are connected to the consumers 104 behind the power consumption meters 105 and are characterized by weather-dependent energy generation are referred to throughout the specification as power sources (or power producers) alternative to the electrical power grid (and/or as “alternative power sources”). For the sake of clarity, it is noted that a renewable energy source (e.g. 121), if connected to the grid in front of a power consumption meter 105, is not considered in this specification as an alternative power source.

The term “weather conditions” used herein should be expansively construed to cover the basic atmosphere conditions (e.g. air temperature, humidity, type and amount of clouds, type and amount of precipitation, air pressure, wind speed, etc.) and derivatives thereof (e.g. the amount of solar irradiance receivable at a plane of a solar panel during certain period, wind power usable by a wind turbine, etc.) having influence on energy generation by alternative power sources.

It is further noted that unless specifically stated otherwise, the terms “energy source”, “energy production” and alike are interchangeable throughout the specification with the terms “power source”, “power production” and alike.

The total power consumption of a dual consumer is a sum of a consumption from the electrical power grid and from a source alternative to the grid (such power consumption is referred to hereinunder as “alternative consumption”). It is noted that certain dual consumers can consume power merely from an alternative power source, i.e. have a zero consumption from the electrical power grid.

It is further noted that certain alternative power sources can produce more power than consumed by respective dual consumers. In certain cases, the excess of power generated by such alternative power sources can be supplied to the grid.

Thus, individual grid power consumption (GPC) measured by power consumption meters 105 for dual consumers is a net (positive or negative) of consumption from the electrical power grid, alternative power consumption and power generation of respective alternative source (when connected to the grid). It is noted that power consumption meters 105 are uncapable to provide direct measurements of the alternative power consumption and/or alternative power generation by an alternative power source, and measure only net of power import/export to/from the grid.

The inventors have recognized and appreciated that there is a need to predict and optimize a network load of the electrical power grid in consideration of alternative power sources and of alternative consumption of one or more dual consumers.

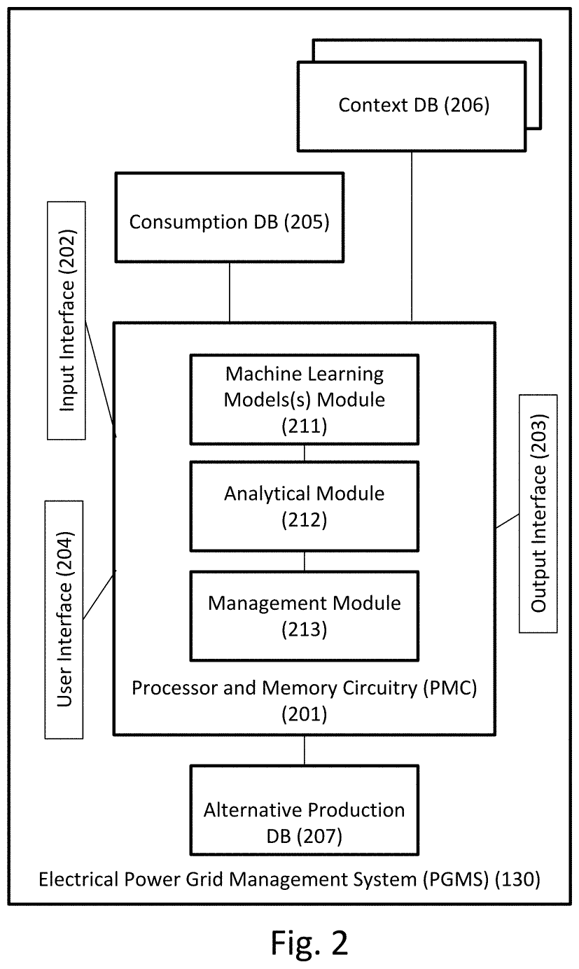

As further detailed with reference to FIGS. 2-XXX, the electrical power grid can be managed with the help of a Power Grid Management System (PGMS) 130 operatively connected to the power grid (e.g. to central electrical power distributor 103).

In accordance with certain embodiments of the presently disclosed subject matter, PGMS is configured to manage the grid so to enable a balance between supply and demand of electrical power in view of the alternative, not measurable by the power consumption meters 105, consumption.

FIG. 2 illustrates a generalized block diagram of the PGMS configured in accordance with certain embodiments of the presently disclosed subject matter.

PGMS 130 comprises a processing and memory circuitry (PMC) 201. PMC 201 comprises a processor and a memory (not shown separately within the PMC) and is operatively connected to an input interface 202 and an output interface 203. PGMS 130 is configured to receive data informative of grid power consumption by the consumers via input interface 202. The respective data (e.g. data (and/or derivatives thereof) from consumer power meters) can be received directly from power consumption meters 105 and/or from one or more external systems (not shown) operatively coupled to the power consumption meters 105 and receiving data therefrom.

PMC 201 is configured to execute several program components in accordance with computer-readable instructions implemented on a non-transitory computer-readable storage medium. Such executable program components are referred to hereinafter as functional modules comprised in the PMC. The functional modules can be implemented in any appropriate combination of software with firmware and/or hardware.

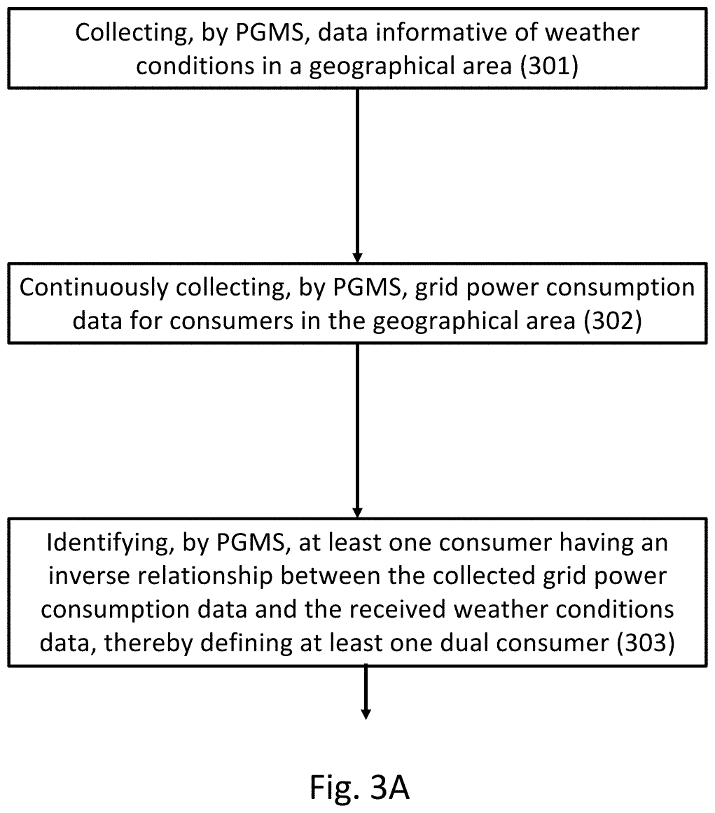

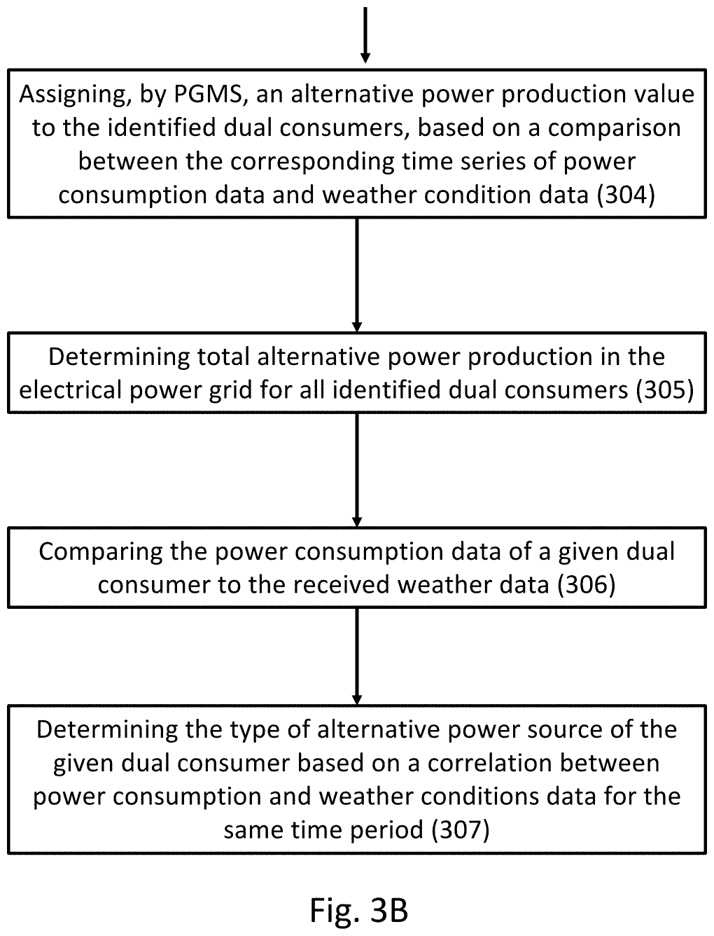

The functional modules in PMC 201 can comprise operatively connected Machine Learning Model (MLM) Module 211, Analytical Module 212 and Management Module 213. MLM Module 211 is configured to accommodate and apply one or more trained Machine Learning Models usable by PGMS when operating as detailed below. The models can be trained by MLM Module 211 and/or externally to PGMS 130. Analytical Module 212 is configured to enable operations further detailed with reference to FIGS. 3-5.

Management Module 213 is configured to use the results from Analytical Module 212 to enable decision(s) related to the management of the electrical power grid. By way of non-limiting example, Management Module 213 can be configured to use the results of analyses to generate a forecast of power production by one or more alternative sources; provide recommendations related to energy generation by the alternative power sources or to connecting the alternative power sources to the electrical power grid; enable actions related to balance between supply and demand of electrical power in the grid in view of alternative power sources, etc. The resulting data can be sent to a rendering system (not shown) via output interface 203. Optionally, the rendering system can be a part of PGMS 103.

A manager of the power grid (a person or an application) can use the data from the Management Module to take a decision related to the power grid (e.g. battery charge/discharge decision, or thermostat set point change, etc.).

Optionally, PGMS 130 can comprise a graphical user interface 204 operatively connected to PMC 201. User interface 204 can enable a user to define geographical areas of interest, operational thresholds and targets, data to be reported/alerted, etc.

PGMS 130 is further configured to comprise a power consumption database 205 operatively connected to PMC 201. Power consumption database 205 is configured to accommodate data informative of individual grid power consumption (GPC) of consumers 104. Accommodated data can include data as provided by power meters 105, such data being timestamped and associated with respective consumers and are referred to hereinafter as consumer power meter (CPM) data. Optionally, the accommodated data can include derivatives of CPM data. For example, PMC 201 can be configured to continuously process the CPM data so to generate, for each consumer 104, a continuously updated grid power consumption (GPC) profile informative of a history of grid power consumption by the respective consumer.

It is noted that unless specifically stated otherwise, it is appreciated that throughout the specification the terms “continuously” refers to actions occurring in accordance with predefined periodicity and/or responsive to one or more scheduled and/or predefined events.

PMC 201 can be further configured to recognize one or more groups of similar consumers (e.g. neighboring consumers, consumers with similar socio-economic levels, etc.) having similar consumption patterns and to group consumers 104 accordingly in accordance with one or more predefined similarity criteria.

PGMS 130 is further configured to comprise one or more context databases 206 operatively connected to PMC 201. The one or more context databases 206 are configured to accommodate data informative of a context related to power consumption by consumers 104.

By way of non-limiting example, context data can be informative of statistical historical daily and season grid power consumption of a group of consumers 104 (e.g. by time-of-day, day-of-week, and season, national and personal holidays, etc.). For example, on national holiday or weekends the consumers can use more electrical devices compared to weekdays where people are usually at work during the day.

Alternatively or additionally, the context data can be informative of statistical historical dependency of grid power consumption of a consumer or a group of consumers 104 on weather conditions in predefined geographical area(s) 110.

The one or more context databases 206 can further include data informative of historical weather conditions and/or weather forecast.

Optionally, PMC 201 can be configured to generate, for each consumer, the GPC profile in association with corresponding calendar data and/or weather conditions data, such profiles can be accommodated in power consumption database 205.

PGMS 130 is further configured to comprise an alternative production database 207 operatively connected to PMC 201.

As noted above, generating electricity by alternative power sources (e.g. such as solar panels, wind turbines, etc.) depends on the weather conditions. For example, the main factors for generating electricity by solar panels include the amount of solar irradiance received at the plane of the solar panel (e.g., per hour), the angle of incidence, the environment temperature, the temperature of the solar panel, cloudiness that can block the solar irradiance, humidity, and the like.

Alternative production database 207 can accommodate data related to alternative power sources, for example, data informative of available spaces to install solar panels and/or wind turbines by consumers 104, data informative of calibration of different types of alternative power sources depending on weather conditions, typical power production values for each type of alternative power sources depending on weather conditions, etc.

Operating PGMS 130 is further detailed with reference to FIGS. 3-5.

It is noted that the teachings of the presently disclosed subject matter are not bound by the Power Grid Management System (PGMS) described with reference to FIGS. 1-2. Equivalent and/or modified functionality can be consolidated or divided in another manner and can be implemented in any appropriate combination of software with firmware and/or hardware and executed on one or more suitable devices. At least part of the functionality of the PGMS can be implemented in a cloud and/or distributed and/or virtualized computing arrangement.

It is further noted that at least part of databases 205-207 can be external to PGMS 130 and operate in data communication therewith via input interface 202 and output interface 203. At least part of the content of databases 205-207 can be received from one or more systems external to PGMS 130.

Referring to FIGS. 3A-3B, there is illustrated a generalized flowchart of determining alternative to an electrical power grid power production in accordance with certain embodiments of the presently disclosed subject matter.

PGMS 130 collects (301) historical and/or forecasted data informative of timestamped weather conditions in a predetermined geographical area 110 (e.g. a city or a part thereof).

PGMS 130 further continuously collects (302) timestamped grid power consumption (GPC) data for one or more consumers 104 in the predetermined geographical area 110.

PGMS 130 can further obtains an electrical power grid layout (receives from an external system and/or generate such layout using GPC data received from the power meters). PGMS 130 can also collects socio-economic status of consumers in the area.

Thus, the collected data are informative of at least of timestamped weather conditions at a predefined geographical area and timestamped grid power consumption data for the one or more consumers in the area. Optionally, the collected data can be further informative of socio-economic status of consumers in the area, average (and/or historical) grid power consumption values for a group of consumers in the geographical area, etc.

PGMS 130 processes the collected data to identify (303) at least one consumer 104 having an inverse relationship between the corresponding time series of grid power consumption data (e.g. from power consumption database 205) and weather conditions data (e.g. from weather condition database). Such consumers are referred to hereinafter also as “inversed consumers”. The inversed consumers can be asserted as dual consumers consuming electrical power also from alternative energy sources.

By way of non-limiting example, PGMS 130 can generate one or more groups of similar consumers (e.g. having similar consumption patterns and/or living in a predefined area and/or living in areas with similar weather conditions, etc.) and identify, within a given group, one or more inverse consumers as consumers having inverse relationship between GPC data and the weather conditions data comparing to the other consumers in the group.

In certain embodiment, identifying the dual consumers can be provided with the help of a machine learning model trained to identify patterns of grid power consumptions depending on weather conditions in the geographical area. For example, PGMS 130 can enable automatic identification of potential dual consumers based on at least one of recorded consumption patterns, geographical conditions and roof prerequisites.

In some embodiments, PGMS 130 can dynamically segment consumers 104 to identify behavior patterns so as to optimize forecasting of power production and/or forecasting of power consumption. For example, PGMS 130 can disintegrate consumption to base load, weather dependent and flexible load and analyze correlations thereof. In some embodiments, geographical aggregation of power production and/or power consumption can be applied to determine net load in each geographical point. In some embodiments, at least one known pattern of power production (e.g., using a solar panel) can be sufficient to learn other patterns (e.g., using machine learning algorithms) and accordingly optimize forecasting.

PGMS 130 assigns (304) to the identified inverse consumers an alternative power production value (e.g., a general unit-less value) as an indicator of an alternative power production. The alternative power production value is defined based on a comparison between the corresponding time series of power consumption data and the weather conditions data. PGMS 130 further determines (305) total alternative power production for all identified inversed consumers. The determined total alternative power production is usable for further forecasting the alternative power production and managing the power grid accordingly.

For a given identified dual consumer, PGMS 130 compares (306) the power consumption data to the corresponding weather conditions data and determines (307) the type of alternative energy source (including power production characteristics thereof) based on a correlation between power consumption and weather conditions data for the same time period. For example, PGMS 130 can receive power production data from a calibrated external power source (e.g., a solar panel with known power production for specific illumination values) to determine an alternative energy source type that is compatible with the measured weather conditions data.

In certain embodiments, PGMS 130 can determine that a given consumer has solar panels and/or a wind turbine (e.g. with the help of data from alternative production database 207). For example, PGMS can use power consumption data of a calibrated power source (e.g., a solar panel with known power production for specific illumination values) to determine a type of alternative energy source that corresponds to the collected weather conditions data.

The determined type of alternative energy source is usable for further forecasting of alternative power production. For example, the maximum value of the generated energy can be determined by the characteristics of the specific solar panel (for example, the maximum generation capacity). Accordingly, it can be possible to predict the future generation of electricity by the solar panels by using the known patterns and features of the influence of weather conditions taking into account the particular characteristics of the solar panel.

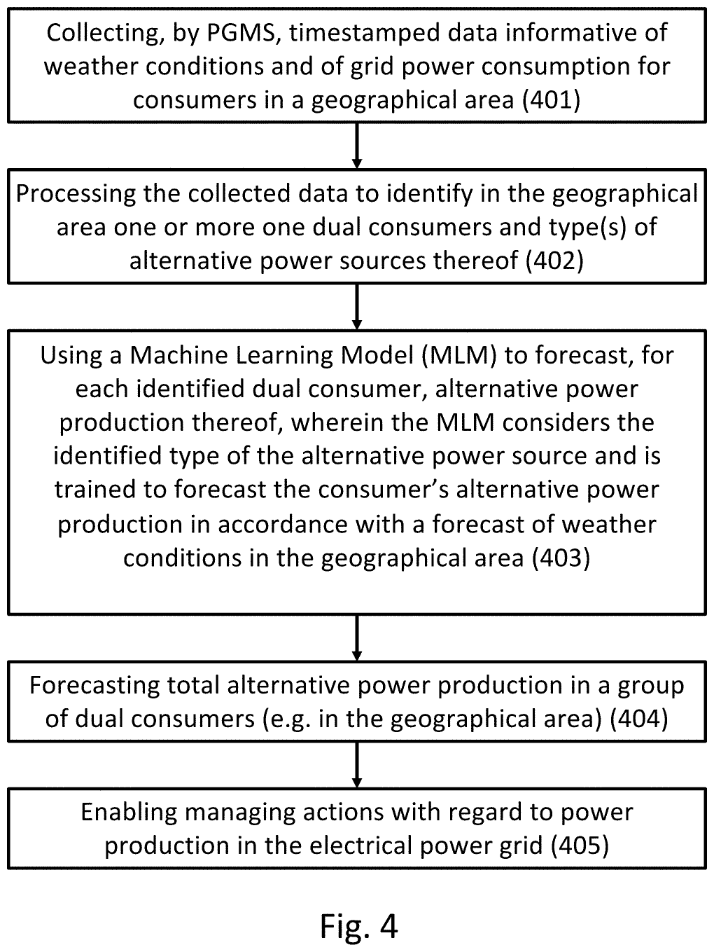

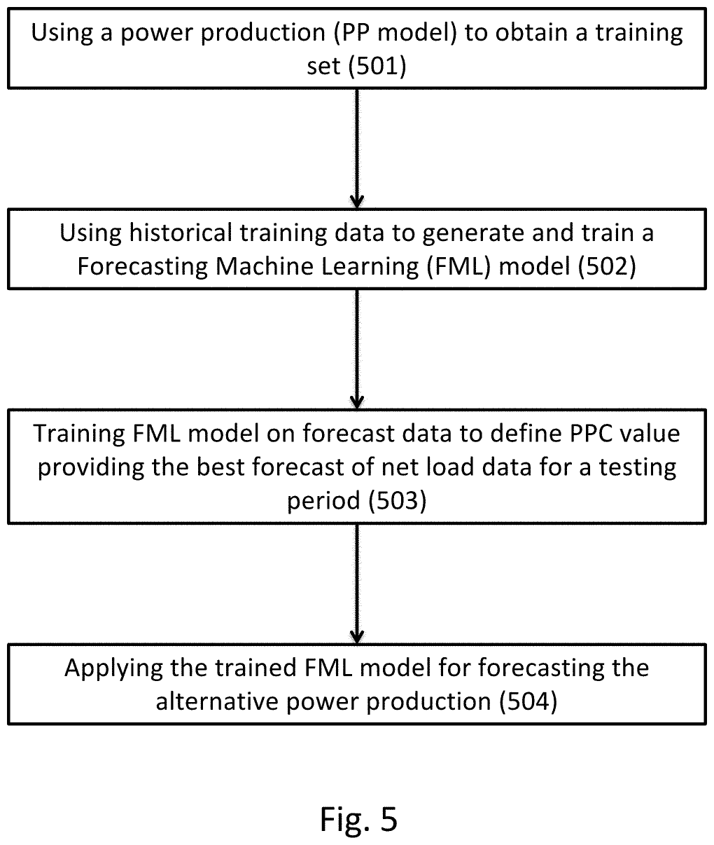

As further detailed with reference to FIGS. 4-5, to improve forecasting of total power consumption in the grid, pre-trained machine learning models can be used to predict the production of energy from the alternative sources, taking into account the location, and/or weather data and/or characteristics of the power production facility. The predicted value of alternative electricity generation to the data on the network load can be usable for predicting the grid power consumption by a particular consumer.

In some embodiments, false identification of dual consumers can be reduced by correlating power production to actual weather conditions (e.g. illumination or wind conditions). In some embodiments, false identification of dual consumers can be reduced by comparison to other consumers in a benchmark group and/or comparison to previous power consumption in a previous time period (e.g., prior to identification of consuming from an alternative power source).

In some embodiments, PGMS 130 can provide the identified dual consumers with energy saving and/or optimizing recommendations.

In some embodiments, PGMS 130 can further analyze the alternative power production by the dual consumers to detect a reduction in power production with time (e.g., due to dust collected on a solar panel) and provide maintenance recommendations to the consumers.

In some embodiments, PGMS 130 can provide energy saving recommendations based on the power production value. In some embodiments, the energy saving recommendations can also be based on weather conditions forecast, for example recommend operating devices with high power consumption (e.g., washing machine) during time periods of potentially high power production from a renewable energy source (e.g., during high illumination time periods for solar panels). In some embodiments, the energy saving recommendations can also be based on at least one of socio-economic status and average power consumption values for a group of consumers in a predefined geographical area. In some embodiments, the energy saving recommendations can also be based on records of past power consumption and/or peak power consumption and/or electrical power rates.

In some embodiments, the energy saving recommendations can also be based on analysis of current power consumption, with forecasting of future power production, and providing a recommendation to install a power production system. For example, PGMS can identify a consumer with time periods of high illumination (e.g., for a solar panel) and/or strong winds (e.g., for a wind turbine) and recommending installing a suitable power production system.

Among advantages of certain embodiments of the presently disclosed subject matter is capability of dynamic point-by-point analysis of end-user historical and/or forecasted power consumption and/or historical and/or forecasted power production in order to generate accurate recommendations for installation of a power production system. Moreover, the generated recommendations can be applied on a set of locations where no existing power production facilities were identified, for example provide recommendations for a consumer without a power production facility to install such facility in a predetermined location (e.g., on the roof).

FIG. 4 illustrates a generalized flowchart of managing the electrical power grid in accordance with certain embodiments of the presently disclosed subject matter.

As detailed above, PGMS 130 collects (401) timestamped data informative of weather conditions and of grid power consumption for consumers in a geographical area. PGMS 130 processes the collected data to identify (402) in the geographical area one or more dual consumers and type(s) of alternative power sources thereof.

As detailed with reference to FIG. 3, the dual consumers can be identified in accordance with the relationship between the consumers' grid power consumption and weather conditions during a certain time period. For example, dual consumers can be identifies as having inverse relationship between their grid power consumption data and the weather conditions data comparing to the other consumers in a group of similar consumers. Optionally, identifying consumers with inverse relationship between the grid power consumption data and the weather conditions data can be provided with the help of a machine learning model trained to identify patterns of grid power consumptions depending on weather conditions in one or more geographical areas.

For a given identified dual consumer, the type (e.g. solar panel, wind turbine, etc.) of alternative energy source can be identified based on a correlation between GPC data of the given consumer, known power production by different calibrated power sources (e.g., a solar panel with known power production for specific illumination values) and weather conditions data for the same time period. Optionally, identifying the type of alternative power source can be provided with the help of a machine learning model trained to identify patterns of alternative power production being a function of weather conditions in one or more geographical areas.

Upon identifying a dual consumer and a type of alternative energy source thereof, PGMS 130 uses a trained Forecasting Machine Learning (FML) Model to forecast (403) the alternative power production by the source. As will be further detailed with reference to FIG. 5, FML model corresponds to the type of the identified alternative energy source and is trained to forecast the consumer's alternative power production in accordance with a forecast of weather conditions in the geographical area.

Further PGMS 130 uses the individual forecasts for dual consumers to forecast (404) the total alternative power production for a group of dual consumers. The group of dual consumers can be constituted by all dual consumers in the geographical area, by dual consumers having the same type of alternative energy source, by dual consumers having similar GPC patterns, etc. Optionally, PGMS 130 can provide the forecast of the alternative power production for the groups organized in accordance with GPC requirements related to management of the power grid (e.g. groups of residents, business clients, critical infrastructure, etc.).

Optionally, the total alternative power production in a group of dual consumers with the same type of energy source can be forecasted (404) without operation (403).

Due to the similarity of the dependency between energy generation and weather conditions for different devices of a certain type of energy sources, data from different energy sources of the same type (e.g. solar panels) can be scaled and combined. Thus, the trained FML model can be applied to the entire group of the dual consumers using the scaled and combined characteristics (e.g. maximum capacity) of the individual alternative power sources as FML input.

PGMS 130 uses the provided forecast(s) to enable (405) management actions with regard to power production/consumption in the electrical power grid. Such management actions can include batteries charge/discharge or controlled thermostat set-point change in a set of points connected to the grid.

In some embodiments, the provided forecast(s) can be used for preparing and enforcing one or more management actions in accordance with the predefined rules. PGMS 130 can provide commands for automatically power distributing between the power grid and/or the power storage facility and/or individual electric appliances in accordance with a forecast results for the given consumer and/or a respective consumers' group. In some embodiments, PGMS can use the provided forecast(s) results to maintain the grid power consumption within a predefined range in order to prevent sharp changes. Non-limiting examples of managing the power grid in accordance with forecasted data are detailed in U.S. patent application Ser. No. 17/613,372 filed May 21, 2020, assigned to the Assignee of the present application and incorporated herewith by reference.

Referring to FIG. 5, there is illustrated a generalized flowchart of forecasting the alternative power production of a dual consumer in accordance with certain embodiments of the presently disclosed subject matter.

As disclosed above, the similarity of the dependency between energy generation and weather conditions for different devices in a certain type of energy sources allows scaling and combining data from different energy sources of the same type. For example, characteristics of the solar panels can include the maximum capacity, the angle of inclination of a solar panel, the dynamic movement of the solar panel following the sun, etc. Scaling of the model (e.g. in the interval from 0 to 1) can be provided in accordance with maximum capacity of particular solar panel.

A respective model describing power production by a certain type of power sources is referred to hereinafter as a Power Production (PP) model. For each type of alternative power sources, PGMS 130 obtains (generates or receives) a model of power production (PP model) by the respective type.

The PP model enables obtaining (501) a training set and training a supervised Forecasting Machine Learning (FML) model (e.g. regression type) using the whole set of available data related to the alternative sources of a certain type, including scaled power production (PP) value as a target value and weather conditions data. The weather conditions data can correspond to each value of generated energy (e.g., weather characteristics for each individual record of generated energy for each individual device, respectively) as features. Optionally, the training set can further include, for each value of generated energy, the additional features specific for the type (e.g. the solar position and the angle between a solar panel plane and solar light in the case of solar panels). The training set can comprise historical data and data forecasted in according to weather forecast(s).

It is noted that a ML model can be trained as a “local model” on data from known power production facilities of certain type of one geographic zone (e.g., a city, a region, a small country, etc.), in which the weather conditions are similar. Alternatively, ML model can be trained as a “global model” on data from all globally known power production facilities of certain type where weather trends may vary, as a “global model”. In some embodiments, the local model, although lacking knowledge of local patterns, may be used for those power production facilities for which there are no local models.

The data in the training set can be shuffled and split into three training subsets: 1st training subset usable for training the initial models, 2nd training subset usable for tuning hyperparameters of an ensembled FML model during the model validation, and 3rd training subset usable for FML model performance estimation.

In some embodiments, generating and training the FML model can be divided into two periods: a training period and a testing period.

During the training period, PGMS 130 uses the historical training data to generate and train (502) a Forecasting Machine Learning (FML) model.

Optionally, generating the FML during the training period can include using the historical data GPC and weather condition data to train and tune at least two ML models. By way of non-limiting example, the models can be selected among XGBoost regression model, random forest regression model, mixed tree regression model, naive statistical models, and/or linear regression model, etc. After all selected ML models are trained and tuned, the ordinary linear regression model may be used for combining the results of all models into one and weighting their impacts (e.g. as ensembling), thereby generating the FML model.

After the FML model (e.g. the ensemble of the trained ML models) is trained, it may be used for grid power consumption forecasts. The FML model forecast GPC values and alternative power production in accordance with weather conditions forecast for the testing period.

The forecasted alternative power production of a given alternative source can be calculated as a scaled model's output multiplied by the maximum capacity of the given source. The calculated forecasted alternative power production (PP value) can be further deducted from the measured GPC values, thereby obtaining forecasted net load data. The forecasted net load data can be compared with net load data measured during the same testing period.

FML is trained during the testing period so to define (503) a PPC (alternative power production capacity) value providing the best forecast for the testing period. By way of non-limiting example, the PPC value can be defined as a value providing the best MAPE (Mean Absolute Percentage Error) of the forecasted net load data during the test period.

The trained FML model can be applied (504) for forecasting the alternative power production in accordance with the weather forecast in the geographical area.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A method of managing an electrical power grid operatively connected to a plurality of consumers in a geographical area, the method comprising, by a computer:
processing timestamped data informative of one or more weather conditions and of individual grid power consumption (GPC) by a plurality of consumers to identify one or more dual consumers connected to one or more alternative power sources with power generating dependable on the one or more weather conditions;
for the identified one or more dual consumers, forecasting alternative power production by respective connected alternative power sources; and
using the provided forecast to enable one or more management actions with regard to power production in the electrical power grid.

2. The method of claim 1, wherein the one or more management actions comprise issuing by the computer at least one command related to at least one of: charging/discharging one or more batteries connected to the grid and controlling thermostat set-point change in a set of points connected to the grid.

3. The method of claim 1, wherein a dual consumer is identified as having inverse relationship between the data informative of the consumer's individual GPC and the data informative of one or more weather conditions comparing to other consumers in a group of similar consumers.

4. The method of claim 1, wherein a dual consumer is identified, with the help of a machine learning model trained to identify patterns of GPC depending on weather conditions in the geographical area, as having inverse relationship between the data informative of the consumer's individual GPC and the data informative of one or more weather conditions.

5. The method of claim 1, wherein forecasting alternative power production by an alternative power source connected to a given dual consumer is provided using a trained Forecasting Machine Learning (FML) Model trained to forecast the alternative power production in accordance with a forecast of the one or more weather conditions in the geographical area.

6. The method of claim 5, further comprising processing the timestamped data to identify types of alternative power sources respectively connected to the identified one or more dual consumers, wherein, for the given consumer, the FML Model corresponds to an identified type of a connected alternative power source.

7. The method of claim 6, wherein the type of the connected alternative energy source is identified with the help of a machine learning model trained to identify patterns of alternative power production being a function of the one or more weather conditions in one or more geographical areas.

8. The method of claim 1, further comprising:
using a trained Forecasting Machine Learning (FML) Model to forecast, for each of identified dual consumers from a group of identified dual consumers, the alternative power production by a respectively connected alternative power source; and
forecasting a total alternative power production in the group of dual consumers and using the provided forecast to enable management actions with regard to power production in the electrical power grid.

9. The method of claim 8, wherein the group of identified dual consumers is constituted by at least one of: all identified dual consumers from the plurality of consumers, identified dual consumers having the same type of the alternative energy source, dual consumers having similar GPC patterns, dual consumers having similar GPC requirements.

10. The method of claim 1, wherein training the FML model comprises:
using historical data informative of the one or more weather conditions and of individual GPC by different consumers to obtain a plurality of FML models having different parameters and initially trained to forecast GPC in accordance with a forecast of the one or more weather conditions;
using the plurality of initially trained FML models to forecast GPC in accordance with the one or more weather conditions forecasted for a testing period and thereby obtaining a set of net load data time series forecasted by the plurality of FML models; and
comparing the forecasted net load data time series in the set of net load data time series with net load data time series measured during the testing period and selecting a FML model providing the best net load forecast for the testing period, thereby giving rise to the trained FML.

11. A system capable of managing an electrical power grid operatively connected to a plurality of consumers in a geographical area, the system comprising a computer configured to:
process timestamped data informative of one or more weather conditions and of individual grid power consumption (GPC) by a plurality of consumers to identify one or more dual consumers connected to one or more alternative power sources with power generating dependable on the one or more weather conditions, wherein a given dual consumer is identified in accordance with a relationship between the consumer's individual GPC and the one or more weather conditions during a certain time period;
for the given dual consumer, use a trained Forecasting Machine Learning (FML) Model to forecast the alternative power production by a connected alternative power source, is trained to forecast the alternative power production in accordance with a forecast of the one or more weather conditions in the geographical area; and
use the provided forecast to enable one or more management actions with regard to power production in the electrical power grid.

12. The system of claim 11, wherein the one or more management actions comprise issuing by the computer at least one command related to at least one of: charging/discharging one or more batteries connected to the grid and controlling thermostat set-point change in a set of points connected to the grid.

13. The system of claim 11, wherein the given dual consumer is identified as having inverse relationship between the data informative of the consumer's individual GPC and the data informative of one or more weather conditions by one of the following: i) comparing to other consumers in a group of similar consumers; ii) with the help of a machine learning model trained to identify patterns of GPC depending on weather conditions in the geographical area.

14. The system of claim 11, wherein the computer is further configured to process the timestamped data to identify types of alternative power sources respectively connected to the identified one or more dual consumers, and wherein, for the given consumer, the FML Model corresponds to a type of a respectively connected alternative power source.

15. The system of claim 14, wherein the type of the connected alternative energy source is identified with the help of a machine learning model trained to identify patterns of alternative power production being a function of the one or more weather conditions in one or more geographical areas.

16. The system of claim 11, wherein the computer is further configured to:
use the trained Forecasting Machine Learning (FML) Model to forecast, for each of identified dual consumers from a group of identified dual consumers, the alternative power production by a respectively connected alternative power source; and
forecast a total alternative power production in the group of dual consumers and use the provided forecast to enable management actions with regard to power production in the electrical power grid.

17. The system of claim 14, wherein the group of dual consumers is constituted by at least one of: all identified dual consumers from the plurality of consumers, identified dual consumers having the same type of the alternative energy source, dual consumers having similar GPC patterns, dual consumers having similar GPC requirements.

18. The system of claim 11, wherein training the FML model comprises:
a. using historical data informative of the one or more weather conditions and of individual GPC by different consumers to obtain a plurality of FML models having different parameters and initially trained to forecast GPC in accordance with a forecast of the one or more weather conditions;
b. using the plurality of initially trained FML models to forecast GPC in accordance with the one or more weather conditions forecasted for a testing period and thereby obtaining a set of net load data time series forecasted by the plurality of FML models;
c. comparing the forecasted net load data time series in the set of net load data time series with net load data time series measured during the testing period, and selecting a FML model providing the best net load forecast for the testing period, thereby giving rise to the trained FML.

19. One or more computers comprising processors and memory, the one or more computers configured, via computer-executable instructions, to perform operations for operating, in a cloud computing environment, a system capable of managing an electrical power grid operatively connected to a plurality of consumers in a geographical area, the operations comprising:
processing timestamped data informative of one or more weather conditions and of individual grid power consumption (GPC) by a plurality of consumers to identify one or more dual consumers connected to one or more alternative power sources with power generating dependable on the one or more weather conditions, wherein a given dual consumer is identified in accordance with a relationship between the consumer's individual GPC and the one or more weather conditions during a certain time period;
for the given dual consumer, using a trained Forecasting Machine Learning (FML) Model to forecast the alternative power production by a connected alternative power source, wherein the FML model is trained to forecast the alternative power production in accordance with a forecast of the one or more weather conditions in the geographical area; and
using the provided forecast to enable one or more management actions with regard to power production in the electrical power grid.

20. The one or more computers of claim 19, wherein the given dual consumer is identified as having inverse relationship between the data informative of the consumer's individual GPC and the data informative of one or more weather conditions by one of the following: i) comparing to other consumers in a group of similar consumers and ii) with the help of a machine learning model trained to identify patterns of GPC depending on weather conditions in the geographical area.
